(19) United States
(12) Patent Application Publication
(10) Pub. No.: US 2013/0273295 A1
(43) Pub. Date: Oct. 17, 2013

(54) SURFACE FINISH FOR COMPOSITE STRUCTURE

(71) Applicant: APPLE INC., Cupertino, CA (US)

(72) Inventors: Kevin M. Kenney, San Jose, CA (US); Michael K. Pilliod, San Francisco, CA (US); John DiFonzo, San Mateo, CA (US)

(73) Assignee: Apple Inc., Cupertino, CA (US)

(21) Appl. No.: 13/628,578

(22) Filed: Sep. 27, 2012

Related U.S. Application Data
(60) Provisional application No. 61/625,008, filed on Apr. 16, 2012.

(51) Int. Cl. B32B 3/14; B32B 3/30; B32B 38/10; B32B 3/08; B32B 37/24

(52) U.S. Cl. 428/67; 264/261; 264/138; 156/245

(57) ABSTRACT

A method is provided for fabricating a composite panel with a surface finish. The method includes securing a polymer film within a first portion of a mold and securing a composite panel within a second portion of the mold. The method also includes holding the first portion of the mold against the second portion of the mold to form a mold cavity between composite panel and the polymer film. The method further includes heating the mold to an elevated temperature, injecting a polymer resin into the mold cavity, and curing the polymer resin to form an integrated structure having a polymer resin layer between the composite panel and the polymer film.

### CROSS-REFERENCE TO RELATED APPLICATION

The present application claims priority to U.S. Provisional Application No. 61/625,008, entitled “Improved Surface Finish For Composite Structure”, filed Apr. 16, 2012, the disclosure of which is incorporated herein by reference in its entirety.

### TECHNICAL FIELD

The present invention relates generally to manufacturing components, and more specifically to manufacturing components utilizing composite materials.

### BACKGROUND

Many composite structures are finished with paint to enhance the appearance of the product and/or to improve resistance to scratch, abrasion, stain, and UV light. Paint is generally applied by spraying but other methods may be employed, including dipping, brushing, or powder coating. Paint, however, has several significant limitations, in particular on composite structures. Adhesion to the substrate is not always adequate, which may result in paint chips. Most paints do not exhibit good hardness, which results in poor resistance to scratch and abrasion.

A typical paint system such as urethane can be reworked after drying because the urethane is a relatively soft finish. Defects like orange peel and dust contamination are removed by sanding with increasingly fine grades of sandpaper followed by polishing with increasingly fine grades of polish, from more abrasive to least abrasive.

Many acrylics and other hard finishes cannot be reworked in this manner because standard abrasives are practically ineffective on very hard surfaces. This lack of reworkability may make them unsuitable for many composite structures. Thus, paint defects result in part scrapage and “yield loss,” which can be very costly since finishing is typically performed at the end of the process when the value of the part is highest.

Defects from a traditional spray painting, including orange peel and dust contamination, can be minimized through careful control of the process but cannot be entirely eliminated. Surface discontinuities present another challenge for paint. For example, composite structures formed of multiple parts that are joined together may have some degree of gap between first and second parts and/or an offset or difference in height or z axis. Paint is generally unable to bridge and fill the gap between the two parts and thus can leave a hairline crack or a depression. Paint is also generally unable to create an even surface over parts with a measurable amount of offset.

### SUMMARY

Embodiments described herein may provide a polymer film over a composite panel in lieu of using conventional painting as a surface finish. The disclosure provides devices and methods for fabricating the composite panel with improved surface finish.

In one embodiment, a method is provided for fabricating a composite panel with a surface finish. The method includes securing a polymer film within a first portion of a mold and securing a composite panel within a second portion of the mold. The method also includes holding the first portion of the mold against the second portion of the mold to form a mold cavity between composite panel and the polymer film. The method further includes heating the mold to an elevated temperature, injecting a polymer resin into the mold cavity, and curing the polymer resin to form an integrated structure having a polymer resin layer between the composite panel and the polymer film.

In another embodiment, a structure is provided for an electronic device. The structure includes a polyurethane layer embedded with glass beads, a portion of the glass beads partially exposed from a top surface of the polyurethane layer. The structure also includes a composite panel. The structure further includes a polymer resin layer attached to a bottom surface of the polyurethane layer and a top surface of the composite panel.

In yet another embodiment, a method is provided for fabricating a composite panel with a surface finish. The method includes laminating a polymer film over a plurality of composite prepreg layers to form a stack. The method also includes placing the stack into a first portion of a mold and covering a top of the stack with a second portion of the mold. The method further includes heating the mold to an elevated temperature, and curing the prepreg layers to form an integrated structure having the polymer film attached to composite layers.

In still another embodiment, a structure is provided for an electronic device. The structure includes a polyurethane layer embedded with glass beads, where a portion of the glass beads are partially exposed from a top surface of the polyurethane layer. The structure also includes a composite panel attached to the polyurethane layer.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

FIG. 1A depicts a sample electronic device having an enclosure formed of a composite material with a surface finish in an embodiment.

FIG. 1B is a cross-sectional view of a stack, including composite prepreg, that may be used to form a composite structure in accordance with one embodiment

FIG. 2 is a system diagram illustrating fabrication of a composite panel from the stack of FIG. 1B.

FIG. 3 is a cross-sectional view of a product using the system of FIG. 2 and the stack of FIG. 1B.

FIG. 4 is a cross-sectional view of a polymer film and a composite panel prior to bonding the film to the panel.

FIG. 5 is a system diagram illustrating a sample mold for forming a panel with an improved surface finish.

FIG. 6 is a cross-sectional view of a finished product formed by the sample mold of FIG. 5.

FIG. 7 is a flow chart illustrating a method of fabricating a composite panel with an improved surface finish by using the system of FIG. 2.

FIG. 8 is a flow chart illustrating a method of fabricating a composite panel with an improved surface finish by using the system of FIG. 5.

### SPECIFICATION

The present disclosure may be understood by reference to the following detailed description, taken in conjunction with the drawings as briefly described below. It is noted that, for purposes of illustrative clarity, certain elements in the drawings may not be drawn to scale.

This disclosure relates generally to composite materials and methods of manufacturing components utilizing composite and polymer materials. Composite materials, as referred to herein, include reinforcing fibers such as glass or carbon (one example of which is carbon reinforced epoxy) and a fiber matrix. The fiber matrix includes, but is not limited to, epoxy.

The present disclosure provides methods for using a co-molded film to replace a conventional paint for composite structures which will be made of prepreg. Depending on finish requirements, different types of film may be used. For a consumer electronic device, the finish requirements may include high hardness for good abrasion/scratch resistance, chemical/stain resistance, and fingerprint resistance. The opacity and/or colors of the surface finish may be, but are not limited to, transparent or semi transparent, or opaque black and white.

This disclosure also provides methods of producing an improved surface finish for already-made composite structures. In particular, a smooth surface finish is produced to exactly or substantially replicate a mold surface, and without defects such as print through, steps, gaps, offsets, orange peel, dust contamination, and sink marks. Additionally, the surface finish has improved resistances to scratch, abrasion, and stain as compared to conventional paint.

A composite may be molded and cured to create various components or parts. The composite may be used in consumer electronic products (e.g., enclosures, housing, internal parts), automobile or manufacturing parts, athletic equipment, and so on. In the case of using prepreg to fabricate a composite panel, a co-molded film, such as a PU film with glass beads, is laminated to several layers of carbon/epoxy prepreg and then cured in a compression mold under heat and pressure. Prepreg is a term for “pre-impregnated” composite fibers where a resin material or matrix material, such as epoxy is already present. The prepreg contains an amount of the resin material used to bond the fibers together and to bond to other components during manufacturing. The prepreg is normally heated to cure. Also, the prepreg may be stored at relatively low temperature to extend shelf life.

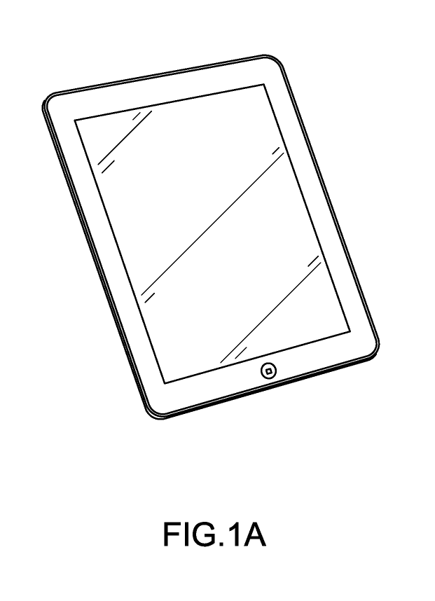

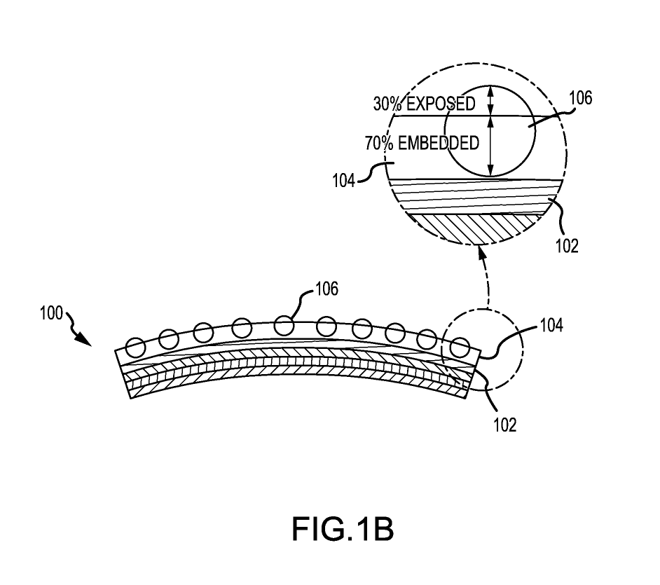

FIG. 1A depicts a sample electronic device having an enclosure formed of a composite material with a surface finish as described herein. The electronic device, as illustrated, is a tablet computing device. However, alternative devices may take the form of a mobile telephone, digital media player, portable computer, personal digital assistant, or substantially any other electronic device.

It should be appreciated that non-electronic and non-portable devices may likewise have surfaces formed in accordance with the present discussion. For example, automobile parts, appliances, and the like may also have surface finishes, compositions, and/or layers as described herein.

FIG. 1B illustrates a stack of prepreg with a co-molded polymer film, prior to curing. Stack 100 includes a polymer film (such as a polyurethane, or “PU,” film) 104 on top of four layers of prepreg 102. Each layer of prepreg 102 may have a different orientation from its adjacent layers to meet the design requirements for strength, stiffness and the like. Stack 100 is cured to form a single structure in a compression mold. It will appreciated by those in the art that number of layers of prepreg may vary between embodiments. The number of layers of prepreg generally affects the thickness of the finished product.

It should be noted that FIG. 1B is an example of a component that may be created with the composite material, and many other components and parts are possible. It will be appreciated by those skilled in the art that the shape and dimension of the component may vary for various applications.

In an embodiment, the polymer film 104 may be a PU film embedded with glass beads or glass bubbles which are hollow. The PU film has several features rendering it suitable for certain uses as a surface finish. First, the PU film is able to conform to intricate shapes when heated and has excellent adhesion to epoxy resin. Second, the PU film is stain and chemical resistant. Third, the PU film 104 may be clear or opaque, such as black, white, or any other color, giving the part a painted appearance but with the aforementioned improvements in surface durability. Fourth, the glass beads or bubbles are generally spaced and sized such that they feel like a continuous surface to a human touch. It will be appreciated by those skilled in the art that the polymer film may include any other polymer films.

As shown in FIG. 1B, PU film 104 includes some glass beads or hollow glass bubbles embedded 106A and some glass bubbles exposed 106B from its surface 108. The glass beads or glass bubbles provide a highly scratch/abrasion resistant surface approaching that of solid glass. The glass beads are commercially available. For example, 3M provides very small and strong glass beads, which may have an average particle size of 46 microns.

The portion of the glass bead that is exposed may vary to meet design requirement for various applications. In a particular embodiment, the glass beads 106 may be partially embedded and partially exposed, for example, with a portion of approximately 70% by diameter of the glass beads 106 embedded into the polyurethane film 104, leaving about 30% by diameter of the glass beads 106 exposed. It will be appreciated by those skilled in the art that the amount of glass beads exposed may be adjusted to provide various film properties.

The fibers for each layer of prepreg 102 may be aligned in the same direction; that is, the fibers of each layer may be unidirectional. In other embodiments, the fibers for each layer of prepreg 102 may be positioned in various directions or woven together. Further, the fibers for the prepreg 102 may be substantially continuous or discontinuous. It will be appreciated by those skilled in the art that the fibers may be substantially any type of material that provides reinforcing strength to a matrix resin such as epoxy. For example, the fibers may be carbon, glass, aramid, polyethylene, polypropylene, quartz, or ceramic.

It should be noted that, although epoxy is discussed as being the base layer for the composite, in some embodiments a resin other than epoxy may be used. For example, polyurethanes, phenolic and/or amino resins, bismaleimides, or polymides may be used as well.

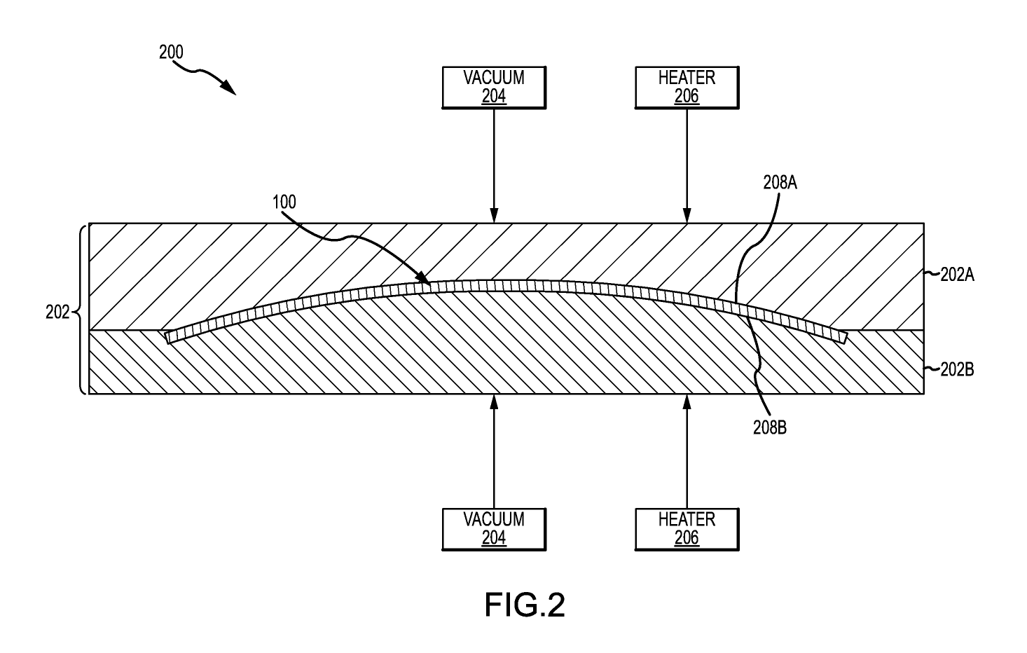

FIG. 2 is a system diagram illustrating fabrication of a composite panel from the stack 100. System 200 includes a compression mold 202 with an upper portion 202A and a lower portion 202B. The stack 100 including the prepreg 102 and PU film 104 is placed between the upper portion 202A and lower potion 202B in the compression mold 202. The PU film 104 is placed against an inner surface 208A of the upper portion 202A and the prepreg 102 is placed against an inner surface 208B of the lower portion 202B.

The system 200 is configured to employ or cooperate with rapid heating and cooling systems (not shown). A heating system may be employed to rapidly heat the mold. In a particular embodiment, system 200 includes heater 206 for heating the mold 202 and prepreg 102 to an elevated temperature to allow fast curing of the prepreg 102. For example, the heater may include high density electric heaters, induction type heaters, or high temperature oil among others.

A pressure is applied to hold the lower portion 202B of the compression mold 202 and the upper portion 202A of the mold 202 together and to apply compaction pressure to the stack 100. After the compression molding, the PU film 104 bonds securely to the prepreg 102 and conforms to an inner surface 208A of the upper portion 202A of the mold 202.

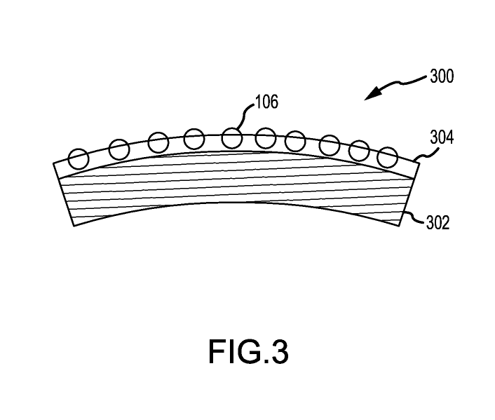

FIG. 3 is a cross-sectional view of a finished product or structure 300 formed by using the system 200 and the stack 100. The finished product 300 includes a PU coating 304 on top of a fiber/epoxy panel 302. The product 300 has a three-dimensional shape in which the carbon fiber (or other suitable fiber) may be either visible or masked by a visible property of the PU film, such as its color or opacity. The product has a hardness and surface durability approaching that of a solid glass in some embodiments.

The polyurethane film 104 is relatively thin. For example, the PU film 104 may be about 0.1 mm to about 0.2 mm thick as a coating for a fiber/epoxy panel 302. The polyurethane coating provides excellent resistance to stains, fingerprints, chemicals, scratches, and abrasion for the composite panel.

In the case of a composite panel made up of multiple parts, such as a fiber/epoxy panel with a glass antenna window, an alternative fabrication method may be required. Because the multiple parts are already cured and bonded together, it is extremely difficult to bond the PU film to the panel without an additional adhesive. While it is possible to perform a second molding operation to apply the PU film to the cured panel/antenna window, it can be difficult to obtain visually satisfactory results. In particular any gaps/offsets are difficult to overcome and result in voids, bubbles, and other cosmetic defects. This difficulty may be overcome by using an opaque or colored film, as one example.

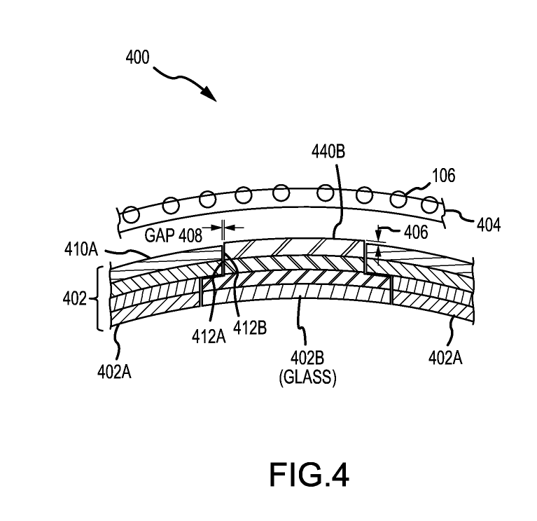

FIG. 4 is a cross-sectional view of stack 400 including a polymer film, such as the aforementioned PU film and a composite panel prior to bonding the PU film to the composite panel in accordance with an embodiment. Composite panel 402 includes a glass section 402B in the middle and a fiber section 402A surrounding or outside the glass section 402B, although other embodiments may place the glass section on an outer surface and/or may omit one or more portions of the carbon section. The composite panel may be assembled by adhesively bonding the two sections 402A and 402B together. The composite panel 402 may include unwanted discontinuities, such as gaps 408 that are between a side surface 412A of the fiber section 402A and an opposite side surface 4128 of the glass section 402B, and offsets 406 that are between a top surface 410A of the fiber section 402A and a top surface 4108 of the glass section 402B. The gaps 408 and offsets 406 are typically the result of tolerances between mating parts, inconsistent adhesive thickness for bonded assemblies, different coefficient of thermal expansion for different materials, etc. For electronic components, the glass section 402B may be added to the panel 402 to ensure electrical insulation, because the carbon fiber/epoxy is conductive. For example, an antenna window is often made of a glass composite. The glass section 402B may be, in some embodiments, a combination of glass and epoxy. The fiber section 402A may be, in some embodiments, a combination of carbon fibers and a resin, such as epoxy.

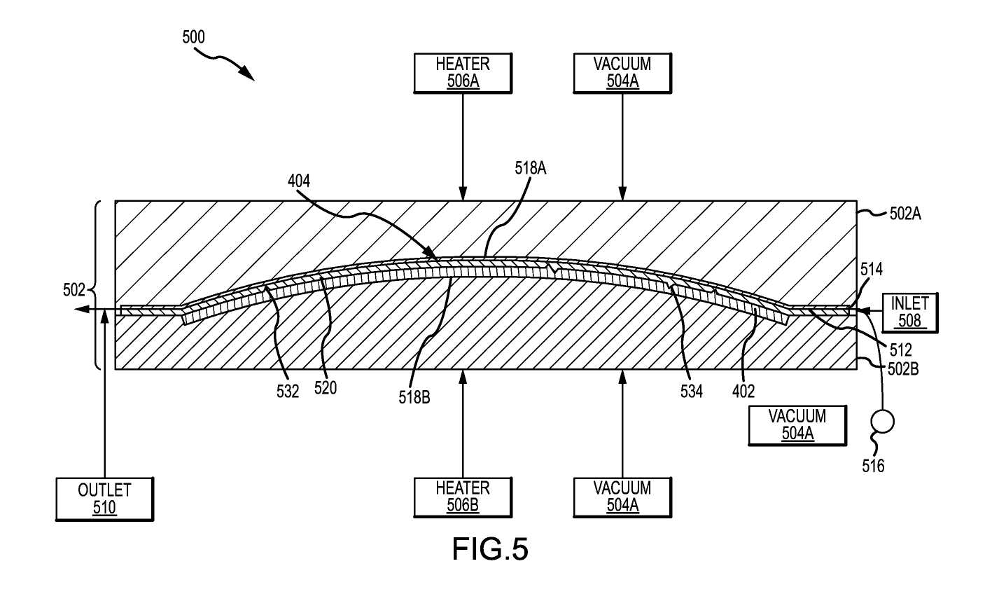

FIG. 5 is a system diagram illustrating fabrication of a panel with an enhanced surface finish by using the composite panel 402 and the polymer film 404. System 500 includes a resin transfer mold 502 with an upper portion 502A and a lower portion 502B. The PU film 404 is placed against surface 518A of the upper portion 502A of the resin transfer mold 502 and the panel 402 is placed against an inner surface 5188 of the lower portion 502B of the resin transfer mold 502. System 500 also includes a vacuum pump 504A for securing the PU film 404 to the upper portion 502A of the resin transfer mold 502 and the panel 402 to the lower portion 502B of the resin transfer mold 502.

System 500 includes an inlet 508 for injecting a polymer resin 520 into a mold cavity or channel 512 from a polymer resin reservoir 516. System 500 also includes an outlet 510 for removal of air bubbles and, in some cases, excessive polymer resin. System 500 also includes a seal 514 for preventing the polymer resin 520 from leaking out of the mold.

System 500 further includes heaters 506A and 506B for heating the resin transfer mold 502 and the materials inside the mold 502 to elevated temperatures. The mold temperature, and the resin temperature, may be elevated to reduce viscosity for easy injection of the polymer resin 520 and to allow fast curing of the polymer resin 520. The polymer resin includes two parts, a thermoset resin and a curing agent, which are pre-mixed prior to the injection.

The method of injecting a resin into a closed mold is used in resin transfer molding (RTM), in-mold coating operations, and the like. System 500 applies a closed mold resin injection technology in a unique fashion. The polymer resin 520 is not used to impregnate fibers as in a conventional RTM, nor is it used as a surface finish as in in-mold coating. Rather, the polymer resin 520 bridges a gap between the composite panel 402 and the PU film 504 to provide a robust connection between the panel and the film without cosmetic defects. Essentially, the resin acts as a bonding agent between panel and film.

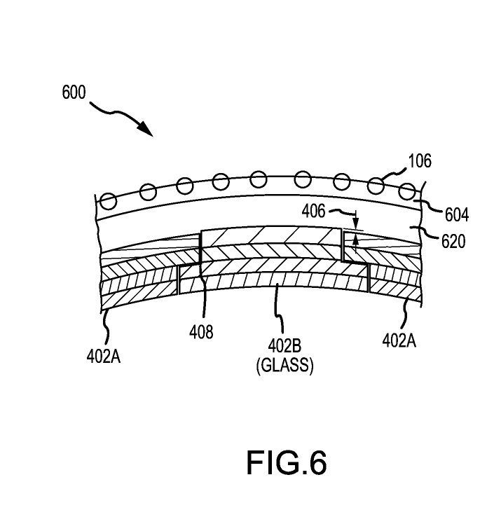

FIG. 6 is a cross-sectional view of a finished product or structure 600 having a composite panel 402 formed by using the system 500. Finished product 600 includes a polymer resin layer 620 between a top finish layer or PU film 404 and composite panel 402. Because the PU film 404 conforms to the mold surface 518A, any gap/offset present in the panel/antenna window does not transfer through to a finished or external surface 610. As illustrated in FIG. 6, the polymer resin layer 620 helps smooth out the imperfections between glass section 402B and fiber section 402A, for example, by filling the gap 408 and covering offset 406. Again, the polyurethane coating, in combination with the glass beads, provides excellent resistance to stains, fingerprints, chemicals, scratches, and abrasions for the composite panel.

The polymer resin may be, but is not limited to, epoxy and PU. In order to minimize the liquid resin thickness and thereby reduce thickness and weight for a composite panel, the polymer resin may have a very low viscosity. This allows the resin to flow through a channel having a very small-cross-section to form a very thin connection between the panel and polymer film. In addition, the polymer resin typically has a short cure time and is injected into the mold quickly, thereby providing a fast cycle time for product production. However, the resin viscosity may increase rapidly when the resin starts to cure. Generally speaking, resin cures faster at an elevated temperature, which increases the viscosity as a result of crosslinking due to curing.

The mold temperature may be maintained below a threshold temperature during a mold filling process. Generally, a thermoset resin undergoes a reduction in viscosity as temperature rises, which can be useful since the mold may fill faster when the resin viscosity is lower. However, the resin may be more reactive and may cure faster at higher temperatures. Therefore, at the threshold temperature, an increased reactivity may offset a reduced filling time because of the lower viscosity, such that the resin cures before filling the mold cavity. Once the mold is completely filled, the temperature may be increased to expedite the cure of the polymer resin.

In a particular embodiment, the polymer resin 520 may be polyurethane. The critical temperature may be about 150° C. for the polyurethane. Practically, it is often useful to have a very thin polymer resin layer. However, it can be more difficult to fabricate a very thin polymer resin layer due to difficulty in injecting the polymer resin into channel with very small cross-section. The polymer resin fills valleys 534, the gaps and offset on the surface of the composite panel and covers peaks 532 on the surface 410 of the composite panel 402 and prevents from print-through. Therefore, the polymer resin layer 520 may need to be adequate to fill surface discontinuities. For example, the polymer resin 520 may have a thickness ranging from 0.05 mm to 0.15 mm for the finished product or structure 600 used in an electronic device. The thickness of the polymer resin layer may increase with the panel size.

As discussed previously, a pressure is applied to hold the lower portion 502B of the mold and the upper portion 502A of the mold 502 together. The pressure may be controlled to be high enough to prevent from resin leaking and to be under a maximum pressure such that there is no print-through or damage to the polyurethane film 404.

After the resin is fully cured, the mold may be cooled. The cooling may bring the panel 300 or 500 to a temperature below its glass transition temperature, or T_{g,} to ensure that the panel 300 or 500 does not plastically deform while de-molding. In addition, the cooling cycle brings the mold temperature down to the point that workers do not need to wear high temperature protection (gloves, aprons) for loading the next part.

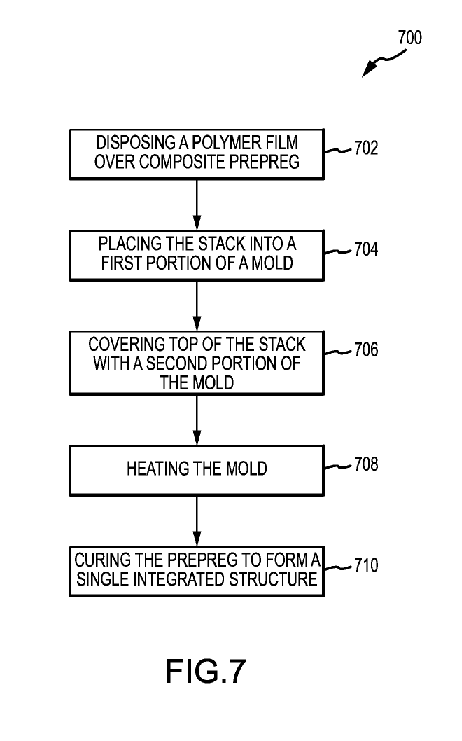

The present disclosure provides a method to mold the PU film 104 and the fiber/epoxy prepreg 102 together to bond the PU film to the prepreg in order to form a single integrated composite structure 300. FIG. 7 is a flow chart illustrating the operations for fabricating a composite panel with a surface finish from the fiber/epoxy prepreg in an embodiment. Method 700 begins with disposing a polymer film over a number of layers of composite prepreg at operation 702. For example, the number of layers of composite prepreg 102 may be arranged at desired angles to increase strength and stiffness of the stack 100. The polymer film 104 is placed over a top layer of the number of layers of the fiber/epoxy prepreg 102.

Method 700 may proceed with placing the stack 100 of prepreg 102, with the PU film 104 thereon, into a first portion of the compression mold at operation 704. For example, a bottom of the layers of prepreg 102 is placed against the mold inner surface 208B of the lower portion 202B of the compression mold 202. Method 700 may proceed with covering a top of the stack 100 with the upper portion 202A to close the compression mold 202 at operation 706. For example, a top of PU film 104 is placed against the mold inner surface 208A of the upper portion 202A.

After closing the mold and applying pressure, method 700 may proceed with heating the mold 202 to an elevated temperature at operation 708, thereby curing the prepreg to form a single integrated composite structure 300.

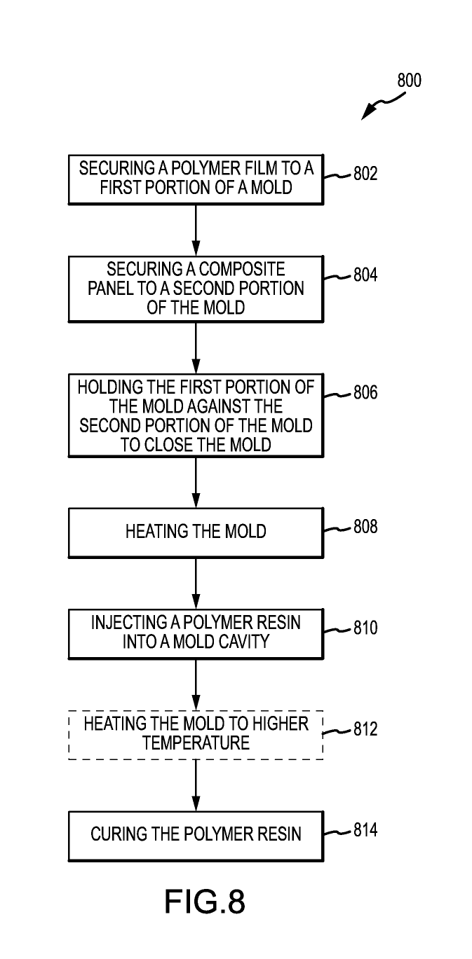

The present disclosure also provides a method to secure the PU film 402 to a panel/antenna window structure 402. FIG. 8 is a flow chart illustrating the operations for fabricating a composite panel with a surface finish from the panel/antenna window structure 402 in an embodiment. Method 800 begins with securing a polymer film to a first portion of a mold at operation 802. For example, PU film 402 is pressed against mold inner surface 518A by heating the upper portion 502A of the resin transfer mold 502 and applying vacuum 504A to the upper portion 502A of the mold 502. Method 800 may proceed with securing the panel 402 with antenna window 402B to lower portion 502B of resin transfer mold 502 at operation 804. For example, vacuum 504A may be used to secure the panel 402 to mold inner surface 518B of lower portion 502B of the resin transfer mold 502.

In an alternative embodiment, operation 802 and operation 804 may be exchanged in order or sequence. For example, the panel 402 may be secured to the lower portion 502B first and the PU film 404 may then be secured to the upper portion 502A.

Method 800 then proceeds to close mold at operation 806, in which the first portion (e.g. upper portion 502A) and the second portion (e.g. lower portion 502B) are held together with pressure to form a mold cavity between the PU film 402 and the panel 402, as illustrated in FIG. 5. Method 800 may proceed with an optional operation of preheating the mold at operation 808, and followed by injecting a liquid polymer resin into the mold cavity between the panel 402 and PU film 404 at operation 810. Method 800 then proceeds with heating the resin transfer mold 502 to a higher temperature to allow faster curing at operation 812, and followed by curing the polymer resin at operation 814.

Both method 700 and method 800 may include cooling the mold and releasing the panel from the mold. Method 800 may also include cutting the polymer resin 520 and PU film 404 near the edges to obtain the finished product 600 as shown in FIG. 6. Methods of cutting include computer numerical control (CNC) machining, abrasive waterjet, and laser.

It should be mentioned that the mold may be cleaned. For example, prior to a new component being created, the mold may typically need to be cleaned in order to remove remnants of the external mold release agent or prior molded component. Chemicals may be sprayed into the mold to remove the mold release agent. Other examples for cleaning the mold may include heating the mold sufficiently above the operating temperature of the resin to “burn off” any residue, as well as using ultrasonic tank cleaning techniques that induce agitation into a liquid solution to remove any remaining portions of the composite.

After cleaning the mold, a mold release may be applied to the mold for easy release of the product, especially when using prepreg during compression molding. Often, mold release agents may need to dry adequately prior to a composite or prepreg being added. The use of the mold release may reduce the risk for damaging a cured composite 300 or 600 during its removal from the compression mold 202 or the resin transfer 502.

One of the benefits for coating the PU film on a composite panel is the ability to incorporate graphics onto the underside of the film; the graphic on the finished panel is embedded in epoxy/PU resin and protected from damage by the PU film with glass beads.

The foregoing description has broad application. For example, while examples disclosed herein may focus on creating composite structures for electronic devices, it should be appreciated that the concepts disclosed herein may equally apply to composites used in other applications, such as sporting equipment, automobiles, sailing vessels, and so on. Similarly, although the composite techniques may be discussed with respect to carbon fiber reinforced polymer or carbon fiber reinforced plastic (CFRP), the techniques disclosed herein are equally applicable to other fiber matrix materials including polyester, vinyl-ester, cyanate ester, nylon, polyether ether ketone (PEEK), polyphenylenesulfide (PPS), and the like. Other reinforcing fibers may also be used, such as, but not limited to, aramid, polyethylene, polypropylene, quartz, and ceramic fibers.

It should also be appreciated that a variety of different items, forms, shapes, and the like may be formed from embodiments described herein and according to embodiments described herein. For example, key caps for a keyboard may be formed and shaped in accordance with the disclosed materials and methods. Likewise, the composite structures disclosed herein may be used to form the exterior of a computing device, such as a smart phone, tablet computing device, computer, and the like. Computer peripherals, such as headphones/earphones, mice and other input devices, connectors, and so on may likewise be formed from the composite materials herein and by the methods disclosed herein. It should further be appreciated that many different pieces, including automotive parts, appliance shells, and many other items may be formed. In any or all embodiments, the film may be colored, patterned or the like to provide a different surface appearance to the finished product.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring of the present invention. Accordingly, the above description should not be taken as limiting the scope of the invention.

Those skilled in the art will appreciate that the presently disclosed instrumentalities teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method of fabricating a composite panel with a surface finish, the method comprising:
securing a polymer film within a first portion of a mold;
securing a composite panel within a second portion of the mold;
holding the first portion of the mold against the second portion of the mold to form a mold cavity between composite panel and the polymer film;
heating the mold to an elevated temperature;
injecting a polymer resin into the mold cavity; and
curing the polymer resin to form an integrated structure having a polymer resin layer between the composite panel and the polymer film.

2. The method of claim 1, the operation of securing a polymer film within a first portion of a mold comprises heating the mold; and applying vacuum to the mold to secure the polymer film to a first inner surface of the mold.

3. The method of claim 1, the operation of securing a composite panel within a second portion of a mold comprises applying a vacuum to secure the composite panel to a second inner surface of the mold.

4. The method of claim 1, wherein the composite panel comprises fibers and a matrix material.

5. The method of claim 1, wherein the composite panel comprises a first section having carbon fiber and epoxy; and a second section having glass fiber and epoxy, the first section surrounding the second section.

6. The method of claim 1, wherein the polymer film is optically clear or opaque.

7. The method of claim 1, wherein the polymer film is flexible to conform to the composite panel.

8. The method of claim 1, wherein the polymer film comprises polyurethane embedded with glass beads.

9. The method of claim 1, wherein the polymer resin comprises at least one of polyurethane and epoxy.

10. The method of claim 9, where the elevated temperature is equal to or less than 150° C.

11. The method of claim 1, further comprising releasing the integrated structure from the mold; and cutting edges of the integrated structure to a desired shape.

12. A structure for an electronic device, the structure comprising:
a polyurethane layer embedded with glass beads, a portion of the glass beads partially exposed from a top surface of the polyurethane layer;
a composite panel; and
a polymer resin layer attached to a bottom surface of the polyurethane layer and a top surface of the composite panel.

13. The structure of claim 12, wherein the polymer resin layer has a thickness ranging from approximately 0.05 mm to approximately 0.15 mm.

14. The structure of claim 12, wherein the polyurethane layer has a thickness ranging from approximately 0.1 mm to approximately 0.2 mm.

15. The structure of claim 12, wherein the polyurethane layer comprises glass beads embedded more than 70% by diameter into the polyurethane layer.

16. The structure of claim 12, wherein the glass beads have a nominal size of 46 μm.

17. The structure of claim 12, wherein the composite panel comprises fibers and a matrix material.

18. The structure of claim 12, wherein the composite panel comprises a first section having carbon fiber and epoxy; and a second section having glass fiber and epoxy, the first section surrounding the second section.

19. A method of fabricating a composite panel with a surface finish, the method comprising:
laminating a polymer film over a plurality of composite prepreg layers to form a stack;
placing the stack into a first portion of a mold;
covering a top of the stack with a second portion of the mold under pressure;
heating the mold to an elevated temperature; and
curing the prepreg layers to form an integrated structure having the polymer film attached to composite layers.

20. A structure for an electronic device, the structure comprising:
a polyurethane layer embedded with glass beads, a portion of the glass beads being partially exposed from a top surface of the polyurethane layer; and
a composite panel attached to the polyurethane layer.
